(19) United States
(12) Patent Application Publication
(10) Pub. No.: US 2003/0150143 A1
(43) Pub. Date: Aug. 14, 2003

(54) Health information card

(76) Inventor: Shirley Hazard, Las Vegas, NV (US)

Correspondence Address: Matthew J. Peirce, Esq., 1550 Starlight Canyon Avenue, Las Vegas, NV, 89123, US

(21) Appl. No.: 10/073,853

(22) Filed: Feb. 13, 2002

(51) Int. Cl. G09F 3/10

(52) U.S. Cl. 40/299.01

(57) ABSTRACT

The present invention is that of a health information card which is designed to relay specific information as to a person's present sexually transmitted disease (STD) status. The health information card is designed to be frequently updated so as to be reasonably accurate with regard to a user's current health condition. While obviously not a guarantee nor an endorsement that a particular person would presently be disease-free, the health information card would be designed to promote a cleaner lifestyle and raise awareness with regard to the presence of STD's and various preventative mechanism in which individuals can reduce or eliminate the chances of getting STD's.

### BACKGROUND OF THE INVENTION

The present invention concerns that of a new and improved health identification card for use by individuals to indicate whether they currently positive or negative for sexually transmitted diseases (STD's).

### DESCRIPTION OF THE PRIOR ART

U.S. Pat. No. 6,223,559 B1, issued to Coleman, discloses a medical identification charm bracelet including a housing for housing an electronic circuit that includes an audible output device and a visual output device that is activatable to draw attention to the I.D. bracelet and the information inscribed on the various bracelet charm attachments to notify medical personnel of various medical conditions of the wearer.

U.S. Pat. No. 6,042,005, issued to Basile et al., discloses a personal identification system for children that includes two forms of identification.

U.S. Pat. No. 5,877,742, issued to Klink, discloses a traditional, yet more stylish, medical identification bracelet which has electronic circuitry to display detailed, patient medical information.

U.S. Pat. No. 5,659,741, issued to Eberthardt, discloses a computer system and method for programming it for storage of individual medical histories on a storage device.

U.S. Pat. No. 5,658,016 issued to Goeken, discloses an attachment for an identification card for providing information, such as medical data.

U.S. Pat. No. 5,215,334, issued to Presson et al., discloses an emergency medical card which includes a first location for displaying a reduced-sized medical data transparency with a detachable lens element for separation from the card to view the medical data contained on the transparency.

U.S. Pat. No. 5,171,039, issued to Dusek, discloses a wallet size laminated medical information card which is made by providing the information on a form at a physician's center.

U.S. Pat. No. 5,161,826, issued to Van Giesen et al., discloses a composite medical information and identity card.

U.S. Pat. No. 4,648,189, issued to Michel, discloses an internally illuminated medical data card in a credit card format containing a summary of the medical history of the bearer germane to his existing medical condition.

U.S. Pat. No. 4,236,332, issued to Domo, discloses a medical record card wherein a supporting card contains a microfilm portion having indicia visible to the human eye coded for particular chronic conditions which effect emergency treatment and having indicia visible by use of a microfilm reader which detail the medical history and identification data of the patient.

### SUMMARY OF THE INVENTION

The present invention is that of a health information card which is designed to relay specific information as to a person's present sexually transmitted disease (STD) status. The health information card is designed to be frequently updated so as to be reasonably accurate with regard to a user's current health condition. While obviously not a guarantee nor an endorsement that a particular person would presently be disease-free, the health information card would be designed to promote a cleaner lifestyle and raise awareness with regard to the presence of STD's and various preventative mechanism in which individuals can reduce or eliminate the chances of getting STD's.

There has thus been outlined, rather broadly, the more important features of a health information card that the detailed description thereof that follows may be better understood and in order that the present contribution to the art may be better appreciated. There are, of course, additional features of the health information card that will be described hereinafter and which will form the subject matter of the claims appended hereto.

In this respect, before explaining at least one embodiment of the health information card in detail, it is to be understood that the health information card is not limited in its application to the details of construction and to the arrangements of the components set forth in the following description or illustrated in the drawings. The health information card is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present health information card. It is important, therefore, that the claims be regarded as including such equivalent constructions insofar as they do not depart from the spirit and scope of the present invention.

It is therefore an object of the present invention to provide a health information card which has all of the advantages of the prior art and none of the disadvantages.

It is another object of the present invention to provide a health information card which may be easily and efficiently manufactured and marketed.

It is another object of the present invention to provide a health information card which is of durable and reliable construction.

It is yet another object of the present invention to provide a health information card which is economically affordable and available for the public.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a front view of the health information card.

FIG. 2 shows an enlarged rear view of the preferred embodiment of the health information card.

### DESCRIPTION OF THE PREFERRED EMBODIMENT

The present invention is that of a health information card 2 which is designed to relay specific information as to a person's present sexually transmitted disease (STD) status. The health information card is designed to be frequently updated so as to be reasonably accurate with regard to a user's current health condition. While obviously not a guarantee nor an endorsement that a particular person would presently be disease-free, the health information card 2 would be designed to promote a cleaner lifestyle and raise awareness with regard to the presence of STD's and various preventative mechanism in which individuals can reduce or eliminate the chances of getting STD's. A person would obtain the health information card 2 by taking a battery of tests that would probe whether the person would have STD's, and the results of these tests would then be displayed on the back of the health information card 2.

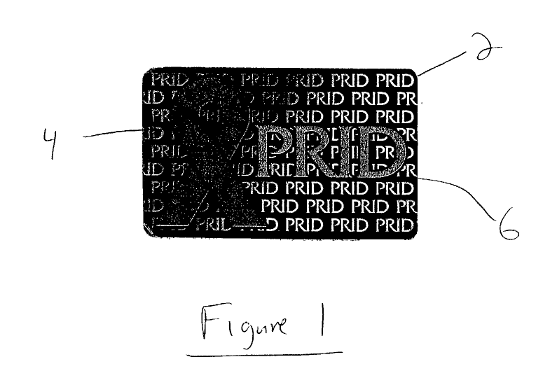

FIG. 1 shows a front view of the health information card 2. A red-crossed ribbon 4 would be present in the left side of the front of the health information card 2. The rest of the health information card 2 could possess a company logo 6 or other indication of origin. The card 2 would be wallet-sized to allow a user to place the card 2 in their wallet and easily transport from place to place.

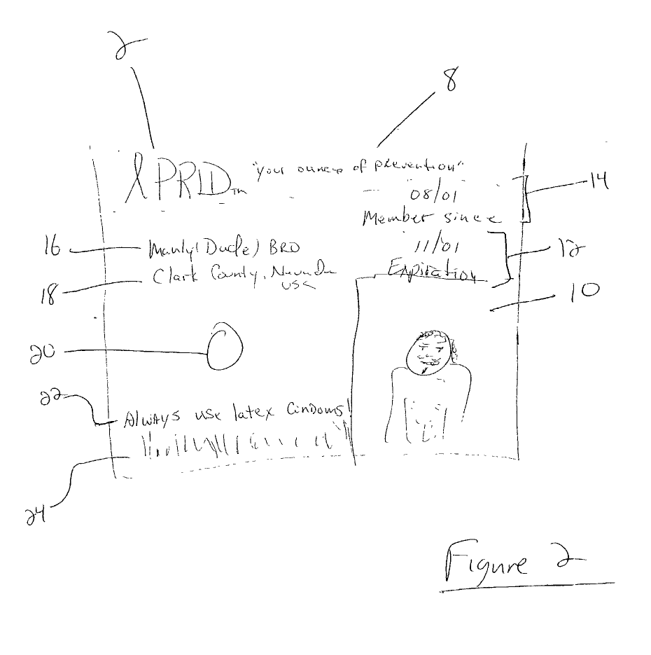

FIG. 2 shows an enlarged rear view of the preferred embodiment of the health information card 2. The rear view of health information card 2 has a lot of information to provide to an individual and other people and includes banner space 8, photo area 10, expiration notice 12, “member since” endorsement 14, name 16, testing origin location 18, status symbol 20, liability statements 22, and bar codes 24.

Banner space 8 would be located across the top of the rear side of the health information card 2 and would be approximately one-third of an inch to one-half of an inch in height. Banner space 8 would allow a user to place a specific slogan, company logo, identification marks, advertisements, or a combination of these various items.

Photo area 10 would preferably be located in the lower right hand corner of the rear side of the health information card 2 and would be designed for a photograph of the holder of the card. Expiration notice 12 and a “member since” endorsement 14 would be designed to be placed immediately above the location of the photograph. Expiration notice 12 would give a specific date that the health information card 2 would be deemed to “expire,” and the “member since” endorsement 14 would give a specific date as to when the holder of the health information card 2 began carrying a health information card 2. Expiration notice 12 would preferably be chosen as a date that would be three months from the date that the holder of the health information card 2 had received his required health testing, but could be set to be a shorter or longer time frame, depending on various circumstances.

Name 16 and testing origin location 18 would preferably be located in the left central area of the rear side of the health information card 2, with name 16 listing the holder's name and the testing origin location 18 listing where the person was last medically tested to obtain their current health information card 2. Immediately below testing origin location would be located status symbol 20, which would preferably be a circle.

If the person was presently “positive” for one or more STD's, then the status symbol 20 would so indicate. In addition, the status symbol could either designate which STD a person would presently be carrying, or alternatively, could have clarifying language immediately next to it mentioning the STD the person would possess. If the person was presently “negative” for STD's, then the status symbol 20 would so indicate. The “positive” or “negative” status of the status symbol 20 is not meant to be a guarantee of the present health of a holder of the health information card 2, but rather, is meant to be an indicator of their health at the time they took the appropriate medical tests for their current health information card 2.

Immediately below status symbol 20 would be a place for liability statements 22, wherein the appropriate legal statements could be made with regard to the health information card 2. Below the area for liability statements 22 would be located at least one bar code 24, which would contain additional medical and personal information about the holder of the card. Bar code 24 would be scannable to get the additional health and personal information.

The particular configurations shown in FIGS. 1 and 2 are not meant to be limiting, but rather, show one possible configuration of the a wide variety of configurations that the information contained in the health information card 2 could be displayed.

What I claim as my invention is:

1. A health information card for relaying health information about sexually transmitted diseases a holder currently possesses or does not possess, the health information card having two sides, a front side and a rear side, the front side of the health information card including a red-crossed ribbon, the rear side of the health information card including
(a) a banner space located across the top of the rear side of the health information card, the banner space being approximately one-third of an inch to one-half of an inch in height,
(b) a photo area preferably located in the lower right hand corner of the rear side of the health information card, the photo area being designed for a photograph of the holder of the card,
(c) an expiration notice immediately above the location of the photograph, the expiration notice giving a specific date on which the health information card would be deemed expired, the specific date on the expiration notice being calculated from the date of performing the health testing necessary to receive the health information card,
(d) a “member since” endorsement placed immediately above the expiration notice, the “member since” endorsement giving a specific date as to when the holder of the health information card began carrying a health information card,
(e) a name area wherein the name of the holder of the health information card would be listed, the name area being located in approximately the left central area of the rear side of the health information card,
(f) a testing origin location area wherein the testing origin location area would preferably be located in the left central area of the rear side of the health information card immediately below the name area, the testing origin location listing where the person was last medically tested to obtain their current health information card,
(g) a status symbol to indicate whether a holder of the health information card would presently have or not have a sexually transmitted disease, and
(h) at least one bar code, the bar code being located in the lower left corner of the rear side of the health information card, the bar code containing additional health and personal information about the holder of the card, the bar code being scannable to retrieve the additional health and personal information.

2. A health information card according to claim 1 wherein the status symbol to indicate whether a holder of the health information card would presently have or not have a sexually transmitted disease would be a specific symbol or design if the holder of the health information card tested negative for the presence of sexually transmitted diseases at the time of their last health testing for sexually transmitted diseases.

3. A health information card according to claim 1 wherein the status symbol to indicate whether a holder of the health information card would presently have or not have a sexually transmitted disease would be a specific symbol or design if the holder of the health information card tested positive for the presence of sexually transmitted diseases at the time of their last health testing for sexually transmitted diseases, the specific symbol or design shown being different than that if the person had tested negative for the presence of sexually transmitted diseases, and further wherein the health information card would include additional clarifying information defining what sexually transmitted disease for which a person would have tested positive.

4. A health information card according to claim 1 wherein the specific date on the health information card would be three months from the date that the health testing was performed for the holder of the health information card.
